(19) United States
(12) Patent Application Publication
(10) Pub. No.: US 2013/0191903 A1
(43) Pub. Date: Jul. 25, 2013

(54) DUAL FACTOR AUTHENTICATION WITH A PROGRAMMABLE TERMINAL DEVICE

(71) Applicant: Aventura HQ, Inc., Denver, CO (US)

(72) Inventors: Joe Jaudon, Sedalia, CO (US); David Lowrey, Denver, CO (US); Adam Williams, Aurora, CO (US)

(73) Assignee: Aventura HQ, Inc., Denver, CO (US)

(21) Appl. No.: 13/746,885

(22) Filed: Jan. 22, 2013

Related U.S. Application Data
(60) Provisional application No. 61/588,759, filed on Jan. 20, 2012.

(51) Int. Cl. H04L 29/06

(52) U.S. Cl. CPC H04L 63/08
USPC 726/7

(57) ABSTRACT

Systems, devices, methods, and software are described for managing virtual sessions based on dual factor authentication. A central server computer system may authenticate a user of a terminal device based on at least one user authentication credential and a unique device identifier received from the terminal device. The virtual session may be associated with the terminal device based on the received unique device identifier and the at least one user authentication credential. The virtual session may be updated according to at least one rule based on the association of the virtual session of the user with the terminal device

### CROSS REFERENCE

The present application claims priority from U.S. Provisional Patent Application Ser. No. 61/588,759, entitled “DUAL FACTOR AUTHENTICATION WITH A PROGRAMMABLE PERSONAL DEVICE,” and filed on Jan. 20, 2012, which is incorporated herein by reference in its entirety for all purposes.

### BACKGROUND

The present invention relates to computer network communication, and more particularly, to updating resource access permissions in a virtual computing environment.

Various computer systems may use a thin-client or a virtual desktop display in conjunction with a central or distributed server computer system or mainframe. Virtualization is a logical representation of a computer in software. By decoupling the physical hardware from aspects of operation, virtualization may provide more operational flexibility and increase the utilization rate of the underlying physical hardware. Although virtualization is implemented primarily in software, many modern microprocessors now include hardware features explicitly designed to improve the efficiency of the virtualization process.

A virtual session can be served to client devices from a central or distributed server computer system. The server may receive input and output over a network or other communication medium established between the device and the server. In some examples, a thin-client device may run web browsers or remote desktop software, such that significant processing may occur on the server. In many instances, roaming users may be delayed as they attempt to authenticate their identities to access their virtual sessions from new locations or devices. This wait time can negatively impact productivity and efficiency. Thus, there may be a need in the art to reduce wait periods as users roam and transition in and out of different workflows.

### SUMMARY

Methods, systems, and devices are described for managing virtual sessions using dual factor authentication.

In a first set of embodiments, an illustrative method of managing virtual sessions may include authenticating a user of a terminal device based on at least one user authentication credential and a unique device identifier received from the terminal device; associating a virtual session of the user with the terminal device based on the received unique device identifier and the at least one user authentication credential; and updating the virtual session of the user according to at least one rule based on the association of the virtual session of the user with the terminal device.

In a second set of embodiments, an illustrative central server computer system for managing at least one virtual session may include at least an authentication module, a session association module, and a session updating module. The authentication module may be configured to authenticate a user of a terminal device based on at least one user authentication credential and a unique device identifier received from the terminal device. The session association module may be configured to associate a virtual session of the user with the terminal device based on the received unique device identifier and the at least one user authentication credential. The session updating module may be configured to update the virtual session of the user according to at least one rule based on the association of the virtual session of the user with the terminal device.

In a third set of embodiments, an illustrative computer program product may include a tangible computer readable device having computer-readable instructions stored thereon The computer-readable instructions may be configured to cause at least one processor, upon execution of the computer-readable instructions, to: receive, at a central server computer system from a terminal device, at least one user authentication credential associated with a user of the terminal device; receive, at the central server computer system, a unique device identifier associated with the terminal device in connection with the receipt of the at least one user authentication credential; associate a virtual session of the user with the terminal device based on the received unique device identifier and the at least one user authentication credential; and update the virtual session of the user according to at least one rule based on the association of the virtual session of the user with the terminal device.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an example system including components configured according to various embodiments of the invention.

FIG. 2 is a block diagram of an example system including components configured according to various embodiments of the invention.

FIG. 3A is a diagram of an example table of virtual session data according to various embodiments of the invention.

FIG. 3B is a diagram of an example table of virtual session data according to various embodiments of the invention.

FIG. 4 is a block diagram of an example central server computer system including components configured according to various embodiments of the invention.

FIG. 5 is a block diagram of an example central server computer system including components configured according to various embodiments of the invention.

FIG. 6 is a block diagram of an example system including components configured according to various embodiments of the invention.

FIG. 7 is a block diagram of an example system including components configured according to various embodiments of the invention.

FIG. 8 is a flowchart diagram of an example method of managing virtual sessions according to various embodiments of the invention.

FIG. 9 is a flowchart diagram of an example method of managing virtual sessions according to various embodiments of the invention.

FIG. 10 is a flowchart diagram of an example method of managing virtual sessions according to various embodiments of the invention.

FIG. 11 is a schematic diagram that illustrates a representative device structure that may be used in various embodiments of the present invention.

### DETAILED DESCRIPTION OF THE INVENTION

Systems, devices, methods, and software are described for managing virtual sessions at a central server computer system based on dual factor authentication. A terminal device may be associated with a unique device identifier, which may be based at least partly on inherent characteristics of the terminal device. A user attempting to access the protected resource with the terminal device may provide at least one authentication credential to the terminal device. The terminal device may transmit the authentication credential(s) and the unique device identifier to an authentication server.

The authentication server may selectively allow or deny access to a virtual session of the user based on an association between the user credentials provided by the user and the unique device identifier associated with the terminal device. If the user is allowed access, the central server computer system may associate the virtual session of the user with the terminal device based on the received unique device identifier and the user authentication credential(s). The virtual session of the user may then be updated according to at least one rule based on the association of the virtual session of the user with the terminal device.

This description provides examples and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

As used herein, the term “virtual session” or “session” refers to a hosted session of a virtual computing environment associated with a particular user that may be accessed from one or more client devices other than the host. For example, a session may include a thin client session, a virtual application session, a virtual machine session, a virtual operating system session, and/or the like. As used herein, a session described as being “between” a host device and a terminal device refers to the exchange of data between the host device and the terminal device, where the data is related to the session hosted at the host device.

As used herein, the term “terminal device” refers to a device configured to provide a user interface for a remotely hosted virtual session to a user associated with the virtual session. A “terminal device” may be, for example, a personal programmable device or a shared programmable device.

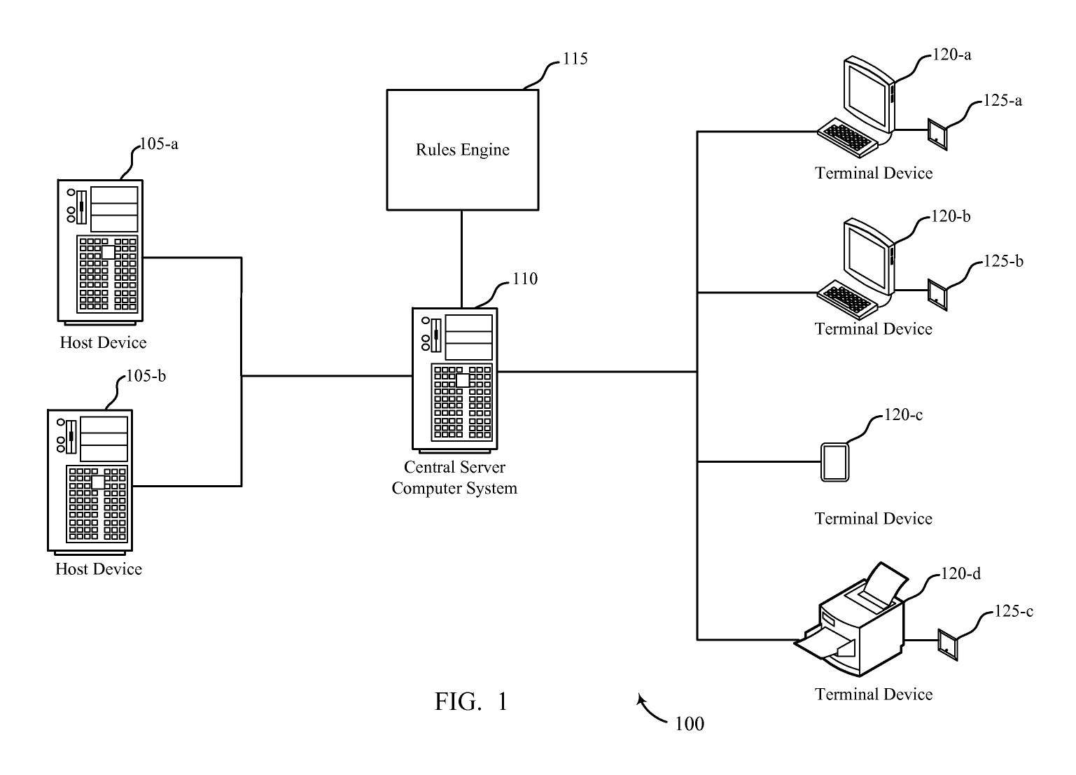

FIG. 1 illustrates an example system 100 including host devices 105, a central server computer system 110, a rules engine 115, terminal devices 120 (e.g., workstation 120-a, workstation 120-b, smartphone 120-c, and printer 120-d), and access devices 125 (e.g., proximity card readers 125). Each of these components may be in communication, directly or indirectly.

The components of the system 100 may be directly connected, or may be connected via a network, which may be any combination of the following: the Internet, an IP network, an intranet, a wide-area network (“WAN”), a local-area network (“LAN”), a virtual private network, the Public Switched Telephone Network (“PSTN”), or any other type of network supporting data communication between devices described herein, in different embodiments. The network may include both wired and wireless connections, including optical links. Many other examples are possible and apparent to those skilled in the art in light of this disclosure. In the discussion herein, a network may or may not be noted specifically. If no specific means of connection is noted, it may be assumed that the link, communication, or other connection between devices may be via a network.

In the system 100 of FIG. 1, the central server computer system 110 may be communicatively coupled with a number of host devices 105 and terminal devices 120. The central server computer system 110 may be configured to forward network packets between the host devices 105 and the terminal devices 120. The central server computer system 110 may be implemented by a single server device or by a number of related components interconnected over a network. A single host device 105 may include one or more servers. Each of the host devices 105 may be configured to provide one or more services. These services may vary in scope and function.

In one example, a number of host devices 105 may host virtual sessions on behalf of users of the terminal devices 120. Each virtual session hosted at a host device 105 may be associated with a particular user. A user may access a session hosted by a host device 105 through one of the terminal devices 120. A terminal device 120 may function as a thin client, and the host device 105-a may provide operating system functionality remotely to the terminal device 120 while the terminal device 120 provides keyboard, video, and mouse (KVM) functionality for the session to the user. Alternatively, the terminal device 120 may execute the operating system based on settings provided for the user from the host device 105.

The central server computer system 110 may be configured to communicate with the terminal devices 120 to permit users of the terminal devices 120 to log on and off of virtual sessions hosted by the host devices 105 at the terminal devices 120. In certain examples, when a user wishes to log onto a virtual session at a terminal device 120, the user may provide one or more authentication credentials to the terminal device 120, which may forward the received authentication credentials to the central server computer system 110. The authentication credentials may include one or more of a username, password, biometric credential, or other token associated with and known or held by the user.

In certain examples, the user may provide at least one authentication credential to the terminal device 120 using an access device 125 peripherally associated with the terminal device 120. In the present example, each of the access devices 125 may be an access card reader configured to receive an access token authentication credential associated with a user when the user places the access card within the general proximity of the access device 125. Alternatively, one or more of the access devices 125 may include biometric readers, keypads, magnetic card readers, wireless transceivers for communicating with mobile devices, or other types of access devices.

When a user provides an access token to an access device 125, rather than processing the received access token only in the operating system of the terminal device 120 associated with the access device 125, the terminal device 120 may generate an access token event and transmit the access token event to the central server computer system 110.

In connection with receiving and forwarding one or more authentication credentials associated with a user to the central server computer system 110, each terminal device 120 may be further configured to transmit a unique device identifier associated with that particular terminal device 120 to the central server computer system 110. Thus, for each attempt to log onto a virtual session at a terminal device 120, the central server computer system 110 may receive, from the terminal device 120, one or more authentication credentials associated with the user attempting to log on in addition to the unique device identifier associated with the terminal device 120.

In certain examples, the unique device identifier may be generated at each terminal device 120 based on inherent properties of that terminal device 120. For example, the unique device identifier may be a hash of a processor serial number and a medium access control (MAC) address of a network interface controller for the terminal device 120. Where a hashing function is used to generate the unique device identifier, in certain examples, each of the terminal devices 120 may use the same hashing function to generate its respective unique device identifier. Additionally or alternatively, the unique device identifier for one or more terminal devices 120 may be assigned to externally and stored locally at the terminal device 120. For example, a unique device identifier may be a telephone number assigned to a mobile terminal device 120 with cellular connectivity.

The central server computer system 110 may authenticate the user at a terminal device 120 using dual factor authentication based on the authentication credentials provided by the user and the unique device identifier associated with the terminal device 120. In certain examples, the central server computer system 110 may apply a set of rules from the rules engine 115 to determine whether the user is permitted to access a virtual session at that particular terminal device 120. For example, the user may be permitted to access his or her virtual session at terminal device 120-a, but a security policy may prevent the user from accessing the virtual session at terminal device 120-b.

If the user attempts to access a virtual session from an unauthorized or unpermitted one of the terminal devices 120, the central server computer system 110 may return an error message or otherwise prevent the user from logging into the virtual session at that particular terminal device 120-b. If, however, the user has been authenticated and is attempting to access the virtual session using a permitted terminal device 120, the central server computer system 110 may associate the terminal device 120 with the user's session. Alternatively, if the user does not have an existing virtual session, the central server computer system 110 may create a new virtual session at one or more of the host devices 105 and associate the virtual session with the terminal device 120.

In certain examples, the central server computer system 110 may begin to initiate the virtual session before authentication of the user has occurred or is completed. One or more default aspects and/or settings may be applied to the session, and the user may be granted certain access permissions for the session (e.g., access permissions to drives, directories, folders, files, applications, etc.). Certain of these default aspects, settings, and access permissions may be based on the location of the terminal device 120-a (e.g., and also be based on user type, client device type, session type, etc.).

Once the virtual session has been associated with the terminal device 120 of the user, the central server computer system 110 may forward session data between the host device(s) 120 and the terminal device 120 such that the user may access session data through the terminal device 120. For example, the user may access applications running on and hosted by the host device(s) 105 through the terminal device 120. In certain examples, as described above, one or more of the host devices 105 may be implemented within the central server computer system 110.

In addition to associating the virtual session with the terminal device 120 of the user, the central server computer system 110 may further apply a set of rules from the rules engine 115 to the combination of the virtual session and the selected terminal device 120 to dynamically update one or more characteristics of the virtual session. For example, the rules engine 115 may identify one or more actions to take with respect to the virtual session based on an identity of the virtual session of the user and the unique device identifier of the terminal device 120 associated with the virtual session. The central server computer system 110 may then take the appropriate action or instruct a terminal device 120 or host device 105 to take the appropriate action.

In certain examples, the central server computer system 110 may store a set of rules locally and implement all of the functionality of the rules engine 115. In alternative examples, the rules engine 115 may be at least partially implemented as a logically or physically separate entity from the central server computer system 110. The rules implemented by the rules engine 115 may a single database of rules, or may include a number of separate and distinct rules databases. The rules engine 115 may include one, or more, relational databases or components of relational databases (e.g., tables), object databases, or components of object databases, spreadsheets, text files, internal software lists, or any other type of data structure suitable for storing data.

There may be terminal device-specific, user-specific, location-specific, and/or virtual session-specific rules for updating one or more aspects, settings, and/or access permissions of the virtual session, applicable to individual users, types of users, sessions, types of sessions, specific applications, types of applications, specific client devices, types of devices, etc. The aspects and settings of the virtual session may, for example, relate to an appearance or display status of a user interface for the virtual session, the status of one or more applications (e.g., executed/running vs. unexecuted/closed) within or associated with the virtual session, the value of one or more session variables, the status (e.g., open, closed) of one or more files in the virtual session, the association of one or more printers or other default peripheral devices with the session, security policies associated with the session, and/or the like. The access permission rules may relate to controlling, restricting, manipulating, or restricting resources. Resources may include applications, computing resources, network resources, or system resources.

As noted above, the rules may be associated with one or more actions. In certain examples, the action may be to allow or block access to a resource, such as, for instance, a folder in a network drive, an application, and/or a network, based on location. In additional or alternative examples, the action may be to create, open, close, or delete an application, a file, a user profile, a setting, or the like. In still other additional or alternative examples, the action may be to open or hide a certain aspect of the session. For instance, an application associated with the session may continue to run in the background, but the rule cause the application to be hidden from the user, thereby preventing the user from viewing or access the running application through the session. Additionally or alternatively, the action may affect some other aspect of the user interface of the session, such as minimizing or maximizing a certain application, file, or folder; reordering the display of graphical elements in the session; moving graphical elements in the session; drawing certain graphical elements in the session; painting certain graphical elements in the session; filling certain graphical elements in the session; clearing certain graphical elements in the session; and/or coloring certain graphical elements in the session.

In additional or alternative examples, the action initiated according to the one or more location-based rules may include displaying certain text or graphics to the user, prompting the user to provide textual or other input to the session, and/or initiating communications via input/output (I/O) devices or ports. In still other additional or alternative examples, the action may include modifying a session variable based on the second location, associating or disassociating one or more printers or other peripheral devices with the session based on the second location, and/or modifying a security setting associated with the session based on the second location.

When the virtual session associated with a user changes its association from a terminal device 120 to a second terminal device 120, the central server computer system 110 may identify any terminal device-specific or location-specific rules applicable to the change in terminal device and initiate actions according to the rules. Thus, the central server computer system 110 may follow individual virtual sessions, and detect when rule is triggered by the association of an existing or new virtual session with a different or new terminal device 120. The central server computer system 110 may call up the resultant action, and either modify the session or transmit modification information accordingly prior to logging the user on to the virtual session at the new terminal device 120. Using this technique, sessions can be adapted dynamically based on associations with individual users and individual terminal devices 120 while minimizing delays perceived by the user when accessing the session for the first time after changing terminal devices 120 and/or locations.

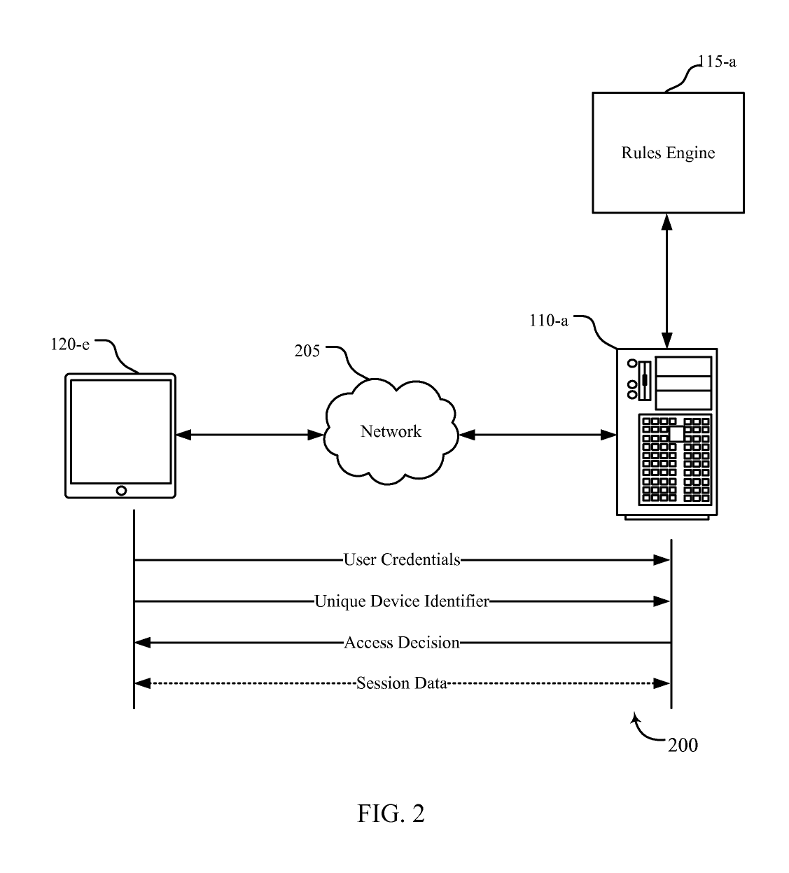

FIG. 2 is a block diagram of an example system 200 for controlled access to a virtual session according to the principles of the present specification. The system of the present example may include a terminal device 120-e, a network 205, a central server computer system 110-a, and a rules engine 115. Each of these components may be in communication, directly or indirectly. The system 200 of FIG. 2 may be an example of the system 100 of FIG. 1. As such, the terminal device 120-e, central server computer system 110-a, and rules engine 115-a may be examples of the terminal devices 120, central server computer system 110, and rules engine 115 described above with respect to FIG. 1.

In the example of FIG. 2, the terminal device 120-e is shown as a tablet computer. However, in additional or alternative embodiments, the terminal device 120 may include one or more laptop computers, desktop computers or workstations, thin clients, smartphones and/or other devices configured to communicate with the central server computer system 110-a over the network 205.

The terminal device 120-e may be programmed to generate a unique device identifier associated with that particular terminal device 120-e. In certain examples, the unique device identifier may be globally unique. In other examples, the unique device identifier may be unique within the network 205 or the set of terminal devices 120 with which the central server computer system 110-a interacts. The unique device identifier may be generated based on inherent characteristics of the terminal device 120-e. For example, the unique device identifier may be generated by hashing a Media Access Control (MAC) address associated with a network interface controller of the terminal device 120-e and a unique serial number associated with a processor of the terminal device 120-e or the terminal device 120-e itself using a hashing function. In certain examples, the hashing function may be specific to the system for accessing the protected resource.

A user of the terminal device 120-e may cause the terminal device 120-e to communicate with the central server computer system 110-a over the network 205 to gain access to a virtual session associated with the user that is hosted and served by the central server computer system 110-a.

To gain access to the virtual session, the user may enter user authentication credentials to the terminal device 120-e. In certain examples, the user may enter the user authentication credentials to the terminal device 120-e in response to a prompt, such as a prompt from an authentication website served by the central server computer system 110-a to the terminal device 120-e. The terminal device 120-e may then transmit the user authentication credentials entered by the user and the unique device identifier associated with the terminal device 120-e to the central server computer system 110-a.

The central server computer system 110-a may communicate with the rules engine 115-a to determine whether access to the virtual session is permitted for the user associated with the provided user authentication credentials through the terminal device 120-e associated with the provided unique device identifier. In certain examples, the rules engine 115-a may be a component of or otherwise implemented by the central server computer system 110-a. Alternatively, the central server computer system 110-a may communicate with the rules engine 115-a over a network or peripheral connection.

If one or more rules implemented by the rules engine 115-a allow for access to the virtual session based on the combination of the provided user authentication credentials and the provided unique device identifier, the central server computer system 110-a may allow the user to access the virtual session associated with the through the terminal device 120-e. On the other hand, if the combination of the user provided authentication credentials and the unique device identifier are not associated with access to the virtual session at the rules engine 115-a, the user may be denied access to the virtual session. The access decision may be transmitted from the central server computer system 110-a to the terminal device 120-e.

If access to the virtual session is granted to the combination of the user and the terminal device 120-e, the central server computer system 110-a may transmit session data to the terminal device 120-e and receive session data from the terminal device 120-e to provide the user of the terminal device 120-e with access to the virtual session hosted at the central server computer system 110-a. For example, the central server computer system 110-a may transmit video and sound information for a user interface of the virtual session to the terminal device 120-e over the network 205 in addition to receiving keyboard, mouse, or other input data for the virtual session from the terminal device.

The central server computer system 110-a may update one or more aspects of the virtual session of the employee based on the association between the virtual session of the user and the terminal device 120-e used to access the virtual session. For example, the user interface of the virtual session may be adapted for display on the terminal device 120-e (e.g., the resolution, size of display, aspect ratio, size of graphical elements, and the like may be changed) in response to the association of the virtual session with the terminal device 120-e.

Additionally or alternatively, one or more access permissions associated with the virtual session may be changed based on the association of the virtual session of the user with the terminal device 120-e. In additional or alternative examples, the execution status (e.g., open, closed, running in background, paused, etc.) of at least one application may be changed based on the association of the virtual session of the user with the terminal device 120-e. In additional or alternative examples, a display status (e.g., displayed, hidden, opacity characteristics, etc.) of one or more elements (e.g., windows, icons, messages, etc.) of the user interface of the virtual session may be changed based on the association of the virtual session of the user with the terminal device 120-e.

In additional or alternative examples, one or more files may be opened or closed in the virtual session based on the association of the virtual session of the user with the terminal device 120-e. In certain examples, a location of the tablet computer may be ascertained, and the updates to the virtual session may further be based on the location of the terminal device 120-e. For example, the virtual session may be updated to associate one or more peripheral devices (e.g., printers, scanners, etc.) with the virtual session based on the peripheral devices that are nearest to the terminal device 120-e.

In addition to authenticating the combination of a user and a device for access to the protected resource, in certain examples the rules engine 115-a may enforce a set of rules to logically bind the device to one or more specific users, a location, a time period, and/or other parameters. For example, consider the scenario of an office floor in which each employee is assigned a tablet computer at the beginning of his or her shift and returns the tablet computer at the end of the shift, but the tablet computers are not permanently assigned to specific employees. At the beginning of the shift, the employee may use one of the tablet computers to log on to a virtual session associated with that employee by providing the employee's authentication credentials at the tablet computer. The tablet computer may transmit the employee's authentication credentials together with its unique device identifier to the company intranet, and access to the virtual session of the employee may be granted on the basis of the transmitted authentication credentials and the unique device identifier.

Once the company intranet authenticates the employee and approves access by the employee to the virtual session of the employee using the tablet computer, a central server computer system of company intranet may logically bind (e.g., associate in a database) the tablet computer to the employee. In certain examples, once the tablet computer has been bound to the employee, only the employee may access or use the tablet computer. In alternative examples, once the employee is bound to the tablet computer, access to the virtual session may be restricted to the employee, but other employees may borrow the tablet computer for other uses. In still other examples, the binding may simply indicate that the employee is currently responsible for the tablet computer. The tablet computer may remain bound to the employee until the employee logs off, for a fixed period of time, until another employee logs on to the tablet, until a predetermined trigger is detected, and/or for other suitable periods of time.

In additional or alternative examples, the virtual session of the user and/or the tablet computer may be bound to one or more specific locations based on the association of the virtual session, the user, and the tablet computer. For example, the tablet computer may be bound to a specified floor of a building. If the tablet computer is removed from that location, the tablet computer may stop functioning or prevent access to the virtual session and/or the company intranet. In certain examples, the tablet computer may be bound to a combination of parameters, such as to the employee for the duration of the employee's shift on a specified floor. Once usage of the tablet computer moves beyond the scope of the combined parameters, access to the virtual session, the company intranet, and/or the functionality of the tablet computer may be reduced or restricted.

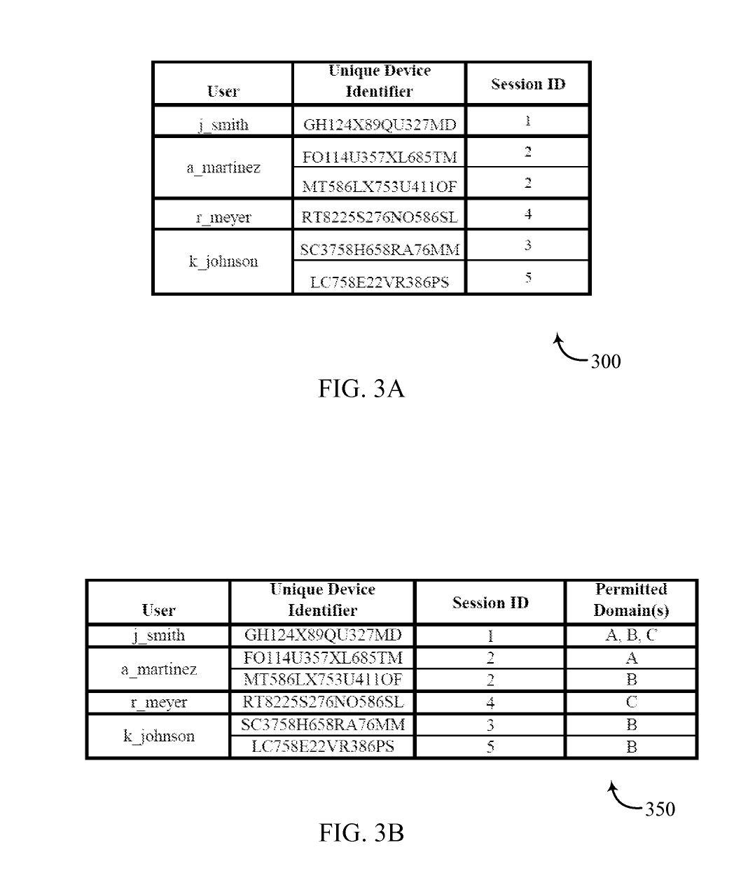

FIG. 3A and FIG. 3B show examples of access tables 300, 350 for virtual sessions. These access tables 300, 350 may be used, for example, by one or more of the central server computer systems 110 and/or rules engines 115 of the previous Figures to determine whether a combination of a user's virtual session a terminal device (e.g., terminal device 120 of the previous Figures), as represented by user authentication credentials received with a unique device identifier, may access certain protected resources.

The access table 300 of FIG. 3A may associate individual users, as represented by username authentication credentials, with unique device identifiers. These associations may indicate combinations of users and terminal devices that have permission to access certain virtual sessions. For instance, the user represented by username j_smith may access virtual session 1 if that user provides valid user authentication credentials (e.g., a correct username and password combination) at the terminal device indicated by unique device identifier GH124X89QU327MD. However, the user may be denied access to virtual session 1 if the same valid user authentication credentials are provided on or in connection with a different terminal device. As further shown in FIG. 3A, the access table 300 may permit a user (e.g., user a_martinez) to access the same virtual session (e.g., virtual session 2) on multiple different terminal devices. As further shown in FIG. 3A, the access table 300 may permit a user (e.g., user k_johnson) to access different virtual sessions using different terminal devices.

In alternative examples, the access table 300 of FIG. 3A may indicate user-device combinations that are disallowed (i.e., blacklisted) from accessing certain virtual sessions. Thus, in these alternative examples, the access table 300 may indicate that the user indicated by the username j_smith is not permitted to access virtual session 1 on or in connection with the terminal device indicated by unique device identifier GH124X89QU327MD. However, in this alternative example, the user indicated by j_smith may be permitted to access virtual session 1 on another terminal device, and other users may be permitted to access the virtual session 1 on or in connection with the terminal device indicated by unique device identifier GH124X89QU327MD.

The access table 350 of FIG. 3B, may associate virtual session-device combinations, as identified by received user authentication credentials and unique device identifiers, with one or more permitted domains. As shown in FIG. 3B, a particular combination of a virtual session associated with a user and a terminal device may be associated with a single permitted domain or with multiple permitted domains. In certain examples, the separate permitted domains may reflect separate protected resources. Alternatively, the separate permitted domains may reflect discrete portions of the same protected resource. As further shown in FIG. 3B, the same user may be permitted to access different domains with the same or different virtual sessions on different terminal devices.

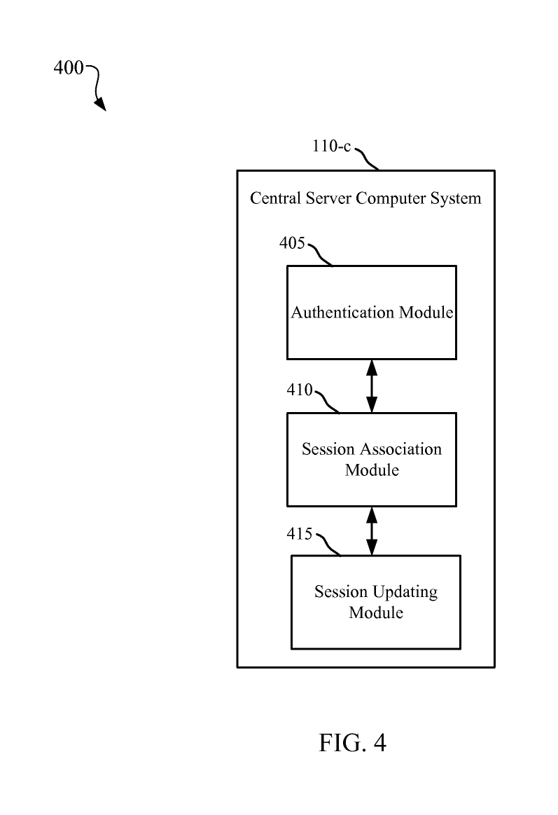

FIG. 4 is a block diagram of one example of a central server computer system 110-c according to the principles described herein. The central server computer system 110-c may be an example of one or more of the central server computer systems 110 described above with reference to the previous Figures. The central server computer system 110-c of the present example may include at least an authentication module 405, a session association module 410, and a session updating module 415.

The authentication module 405 may be configured to receive at least one authentication credential and a unique device identifier from a terminal device. The authentication module 405 may authenticate a user of the terminal device based on both the at least one authentication credential and the unique device identifier received from the terminal device.

The session association module 410 may be configured to associate a virtual session of the user with the terminal device based on the received unique device identifier and the at least one user authentication credential. In certain examples, the authentication module 405 and the session association module 410 may be further configured to determine, based on the unique device identifier received from the terminal device, whether the user has permission to access the virtual session of the user through that particular terminal device. The association of the virtual session of the user with the terminal device may be in response to a determination that the user is authorized to access the virtual session at that terminal device.

In certain examples, the association of the virtual session of the user with the terminal device may further include binding the virtual session to the terminal device for a predetermined amount of time, until the user logs off of the terminal device, or until another user logs on to the terminal device. In certain examples, the central server computer system 110-c may prevent a second user from logging on to or using the terminal device while the terminal device while the first user is logged on to his or her virtual session at the terminal device. In certain examples, the virtual session and/or terminal device may also be bound to a location while the terminal device is bound to the virtual session of the user.

The session updating module 415 may be configured to update the virtual session of the user according to at least one rule based on the association of the virtual session of the user with the terminal device. In certain examples, the session updating module 415 may determine a location of the terminal device based at least in part on the unique device identifier, and the virtual session may be updated based on the location of the terminal device. In certain examples, the central server computer system 110-c may maintain a database of the location of each terminal device. Additionally or alternatively, the central server computer system 110-c may track the location of individual terminal devices, or the terminal devices may report their locations to the central server computer system 110-c when a user logs on to a virtual session.

As described above, updating the virtual session based on the association of the virtual session with the unique identifier of the terminal device and/or the location of the terminal device may include, but is not limited to: adapting a user interface of the virtual session for display on the terminal device, changing at least one access permission associated with the virtual session, changing an execution status of at least one application of the virtual session, changing a display status of one or more elements of a user interface of the virtual session, opening or closing a file in the virtual session, and/or other actions to update the virtual session. In certain examples, the session updating module 415 may perform one or more of these actions to update the virtual session prior to the user receiving access to the virtual session at the terminal device.

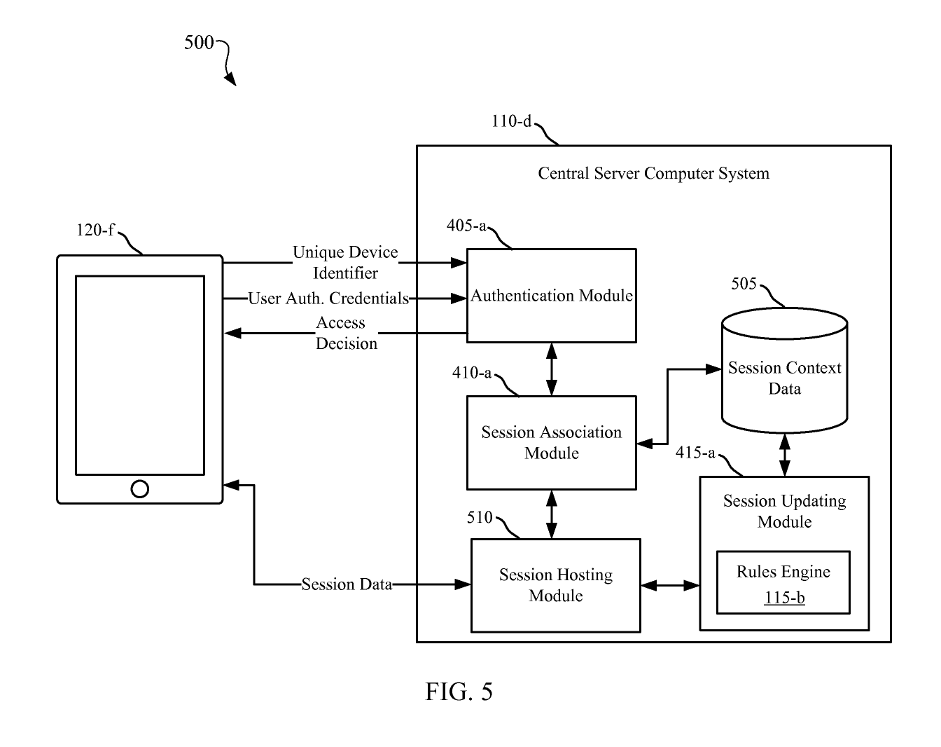

FIG. 5 illustrates an example system 500 in which a central server computer system 110-d may communicate with a terminal device 120-f to provide access to a virtual session. The system 500 may be an example of one or more of the system 100, 200 described above with respect to the previous Figures. The terminal device 120-f, central server computer system 110-d, and rules engine 115-b may be examples of one or more of the terminal devices 120, central server computer systems 110, and rules engines 115 of the previous Figures, respectively. The central server computer system 110-d may additionally be an example of one or more of the host devices 105 described above with reference to FIG. 1.

The central server computer system 110-d of FIG. 5 may include an authentication module 405-a, a session association module 410-a, a data store of session context data 505, a session updating module 415-a, and a session hosting module 510. These components may be in communication with each other, directly or indirectly.

The authentication module 405-a may communicate with the terminal device 120-f to receive a unique device identifier for the terminal device 120-f and authentication credentials provided by a user of the terminal device 120-f. The unique device identifier may be based at least in part on one or more inherent characteristics of the terminal device 120-f, such as a MAC address and a serial number of the terminal device 120-f or a component (e.g., processor, network interface controller, etc.) of the terminal device 120-f. The user authentication credentials may include a username and password, an access token from an access card or other physical credential, and/or other types of credentials to verify the identity of the user of terminal device 120-f.

The authentication module 405-a may perform dual factor authentication based on the user authentication credentials and the unique device identifier to determine whether to grant the user of the terminal device 120-f access to an existing virtual session associated with the user or a new virtual session based on an association between the received unique device identifier and the received user credentials known to the central server computer system 110-d. In certain examples, the authentication module 405-a may determine whether to grant access to the virtual session based on one or more access tables stored by the central server computer system 110-d, such as the tables 300, 350 described above with reference to FIG. 3A and FIG. 3B, respectively. Once an access determination has been made based on the association (or lack thereof) between the received unique device identifier and user authentication credentials, the authentication module 405-a may communicate the access decision to the terminal device 120-f.

If access to the virtual session is granted to the user at terminal device 120-f, the session association module 410-a may access the session context data store 505 to associate the unique device identifier of the terminal device 120-f with the virtual session of the user as context data for the virtual session. The context data for the virtual session may be further updated to include other parameters, such as the location of the terminal device 120-f or which authentication credentials were presented by the user for access to the virtual session.

The session updating module 415-a may apply a set of rules implemented by rules engine 115-b to the session context data stored for the virtual session of the user in the session context data store 505 to update certain aspects of the virtual session, as explained in more detail above. For example, the session updating module 415-a may update one or more aspects of the user interface of the virtual session, one or more access permissions associated with the virtual session, or the association of one or more peripheral devices with the virtual session.

The session hosting module 510 may host one or more applications to implement the virtual session of the user. In certain examples, the session hosting module 510 may run an operating system instance associated with the user such that the user may access a desktop of the operating system instance via the terminal device 120-f. Additionally or alternatively, the session hosting module 510 may run one or more applications within the context of an operating system and allow the user to access the applications remotely at the terminal device 120-f. In still other examples, the terminal device 120-f may run an operating system or other application remotely, and the session hosting module 510 may provide configuration information for the operating system or the application to the terminal device 120-f such to maintain a consistent user context across multiple terminal devices 120. In certain examples, the session hosting module 510 may not allow the terminal device 120-f access to session data for the virtual session of the user until the session updating module 415-a has updated the virtual session based on any changes in the session context data 505 for the virtual session.

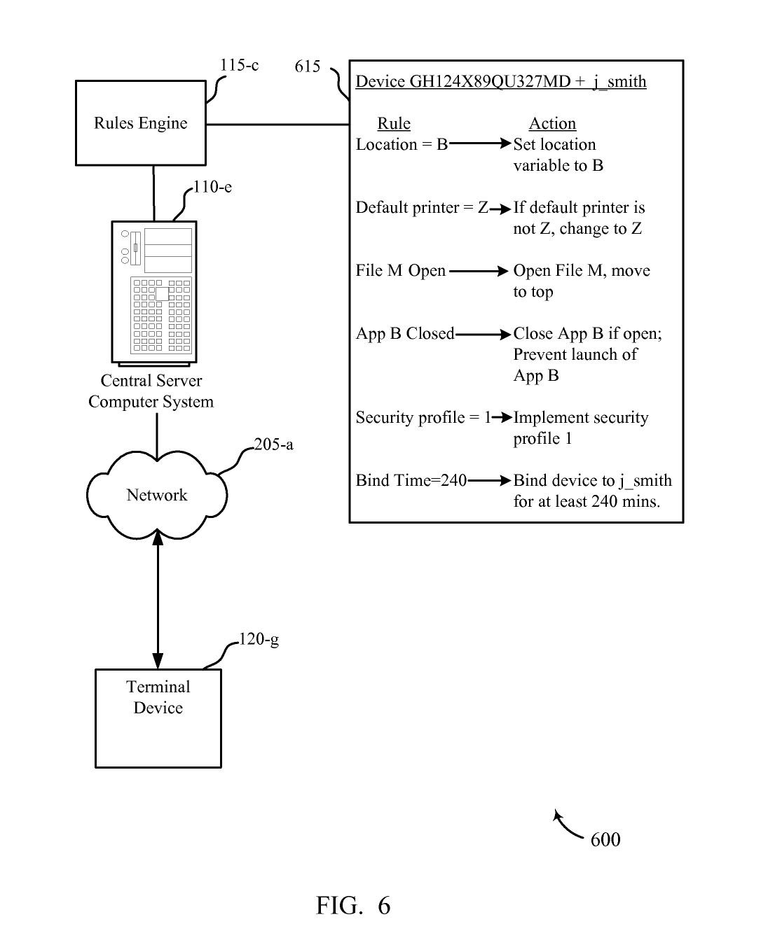

FIG. 6 is a block diagram illustrating an example of rules that may be implemented to update a virtual session upon associating the virtual session with a new terminal device 120-g, as described above. The system 600 of the present example may include central server computer system 110-e, rules engine 115-c, network 205-a, and terminal device 120-g. These components may be in communication with each other, directly or indirectly. The system 600 may be an example of one or more of the systems 100, 200, 500 described above with reference to the previous Figures. In the present example, the central server computer system 110-e may also function as a host device (e.g., host device 105 of FIG. 1) for virtual sessions.

In the example of FIG. 6, only one terminal devices 120-g is shown for clarity, but multiple terminal devices 120 may be disposed at different locations and communicate with the central server computer system 110-g to provide access to virtual sessions over network 205-a. The location of each terminal device 120 may be known or ascertainable by the central server computer system 110-e.

In the present example, a user may have initiated a virtual session at a different terminal device, logged off of that terminal device, and moved to terminal device 120-g. Thus, prior to logging on to terminal device 120-g, the central server computer system 110-e may maintain the virtual session associated with the user, but the virtual session may not be associated with or bound to any terminal device 120.

Once terminal device 120-g receives authentication credentials from the user, the terminal device 120-g may transmit the authentication credentials and a unique device identifier for the terminal device 120-g to the central server computer system 110-e. The central server computer system 110-e may determine that the user has moved from a previous location to the location of terminal device 120-g. The central server computer system 110-e may perform dual factor authentication using the received authentication credentials and the unique device identifier to determine whether the user is permitted to access the virtual session at terminal device 120-g. In certain examples, security restrictions or certain characteristics of terminal device 120-g may prevent the user from accessing the virtual session at terminal device 120-g, even if the authentication credentials of the user are valid.

If the dual factor authentication process determines that the user is permitted to access the virtual session hosted by central server computer system 110-e at terminal device 120-g, the central server computer system 110-e may update context information stored for the virtual session to associate the virtual session with terminal device 120-g. The central server computer system 110-e and rules engine 115-c may also retrieve and enforce a set of rules 615 based on the association of the virtual session of the user with the terminal device 120-g to update the virtual session of the user. In certain examples, the virtual session of the user may be updated prior to the user gaining access to the virtual session at terminal device 120-g.

The central server computer system 110-e may perform one or more actions associated with the rules with respect to the existing virtual session for the user to enforce or otherwise implement the set of rules 615 applicable to the user when associated with the terminal device 120-g. In the example of FIG. 6, a first rule may provide that a location variable associated with the existing session should be set to B. The action associated with the first rule may include setting the location variable to B for the existing session. A second rule may provide that a default printer for the session is Z. The action associated with the second rule may include configuring the session such that the default printer is Z. A third rule may provide that file M is to be open at location B. The actions associated with the third rule may include opening file M and moving a window containing file M to the tope of a user interface for the virtual session. A fourth rule may provide that application B is to be closed at location B. The actions associated with the fourth rule may include closing application B if it is open in the existing session, and taking steps to preventing the future launch of application B at location B. A fifth rule may provide that a security profile for the virtual session is to be set to level 1 while the virtual session of the user is associated with the terminal device 120-g. The action associated with the fifth rule may include adjusting the configurations and settings of the virtual session to implement a predefined level 1 security profile. A sixth rule may provide a binding time of 240 minutes for the virtual session. The action associated with the sixth rule may include binding the terminal device to the user for 240 minutes such that only j_smith is able to access a virtual session or other protected resource using the terminal device 120-g for 240 minutes. Additionally or alternatively, the terminal device 120-g may be bound to a location or other parameter.

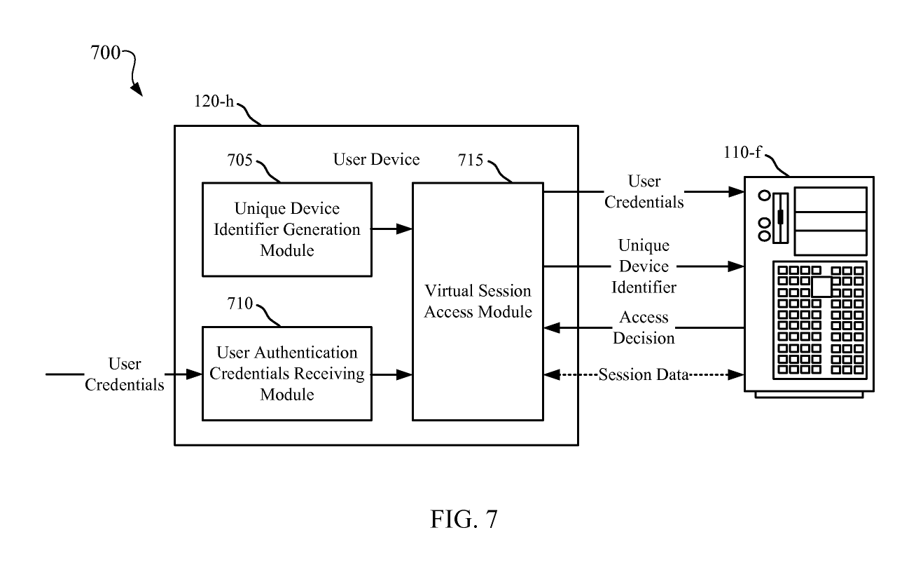

FIG. 7 illustrates an example system 700 in which a terminal device 120-h communicates with a central server computer system 110-f to gain access to a virtual session. The system 700 of FIG. 7 may be an example of one or more of the systems 100, 200, 500, 600 described above with reference to previous Figures. The terminal device 120-h may be an example of one or more of the terminal devices 120 of previous Figures, and the central server computer system 110-f may be an example one or more of the central server computer systems 110, rules engines 115, and/or host devices 105 of previous Figures.

The terminal device 120-h of the present example may include a unique device identifier generation module 705, a user authentication credentials receiving module 710, and a virtual session resource access module 715. Each of these components may be in communication, directly or indirectly. The unique device identifier generation module 705 may be configured to generate a unique device identifier for the terminal device 120-h based at least in part on inherent characteristics of the terminal device 120-h. In certain examples, the unique device identifier generation module 705 may generate the unique device identifier by combining and/or hashing a MAC address associated with a network interface controller of the terminal device 120-h with one or more serial numbers associated with the terminal device 120-h. In certain examples, the hashing function or parameters used to generate the unique device identifier may be selected as a function of a current time, a current location, a current status of the terminal device 120-h, or other factors.

The user authentication credentials receiving module 710 may be configured to communicate with a user to receive user authentication credentials associated with that user. As described above, the user credentials may include a combination of a username and a password associated with the user. Additionally or alternatively, the user authentication credentials may include biometric data received at the terminal device 120-h, a digital certificate uploaded to the terminal device 120-h by the user, and/or any other user authentication credential that may suit a particular application of the principles described herein.

The user authentication credentials receiving module 710 may display a login screen or otherwise prompt the user to enter the user credentials. In certain examples, the prompt may be received from the central server computer system 110-f, such as in a login web page served by the central server computer system 110-f in response to a request for access to the virtual session. Additionally or alternatively, the user authentication credentials receiving module 710 may autonomously prompt the user to provide the user credentials.

The virtual session access module 715 may be configured to receive the unique device identifier from the unique device identifier generation module 705 and the user authentication credentials from the user authentication credentials receiving module 710. The virtual session access module 715 may be further configured to communicate with the central server computer system 110-f to request access to an existing virtual session associated with the user or a new virtual session generated for the user. As part of this process, the virtual session access module 715 may provide the user credentials and the unique device identifier to the central server computer system 110-f. The virtual session access module 715 may receive an access decision response from the central server computer system 110-f based on an association between the user authentication credentials and the unique device identifier in a data store associated with the central server computer system 110-f.

If access is granted to the user at the terminal device 120-h, the central server computer system 110-f may enforce one or more rules based on the association of the virtual session with the terminal device 120-h to update the virtual session. Following the updating of the virtual session, session data may be exchanged between the virtual session access module 715 and the central server computer system 110-f.

In certain examples, the terminal device 120-h may also include one or more modules (not shown) for logically binding the terminal device 120-h to the user, to a location, to a period of time, and/or any other suitable criterion based on a set of one or more rules. If the conditions of the binding are not met (e.g., someone other than the bound user attempts to access the terminal device 120-h or the terminal device 120-h is removed from a bound location), the terminal device 120-h may suspend one or more elements of functionality until the conditions of the binding are fulfilled.

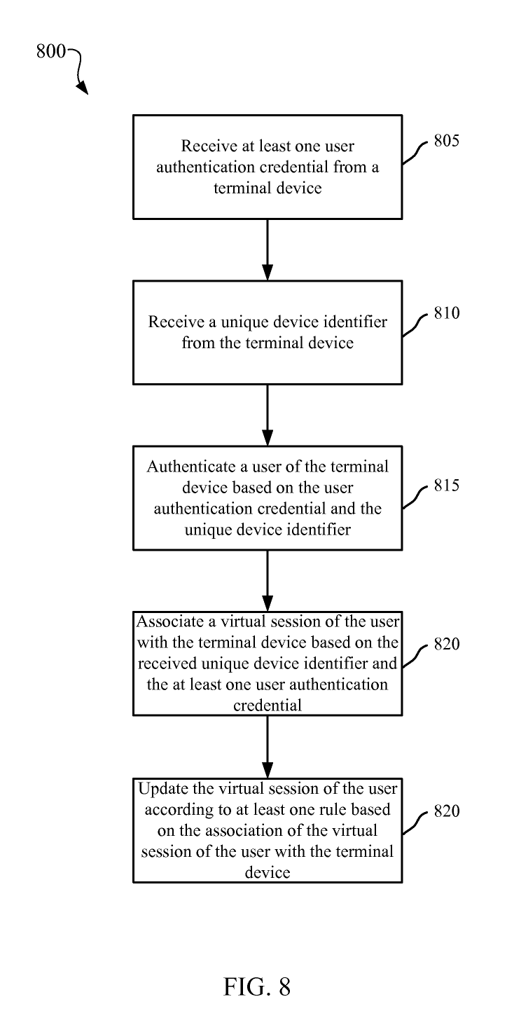

FIG. 8 is a flowchart diagram of an example method 800 of managing sessions according to the principles of the present disclosure. The method 800 may be performed, for example, by one or more of the central server computer systems 110, rules engines 115, or host devices 105 of the previous Figures.

At block 805, at least one user authentication credential may be received from a terminal device. At block 810, a unique device identifier may be received from the terminal device. In certain examples, the at least one user authentication credential and the unique device identifier may be received together in the same transmission from the terminal device.

At block 815, a user of the terminal device may be authenticated based on the combination of the user authentication credential and the unique device identifier. At block 820, a virtual session of the user may be associated with the terminal device based on the received unique device identifier and the at least one user authentication credential. At block 825, the virtual session of the user may be updated according to at least one rule based on the association of the virtual session of the user with the terminal device.

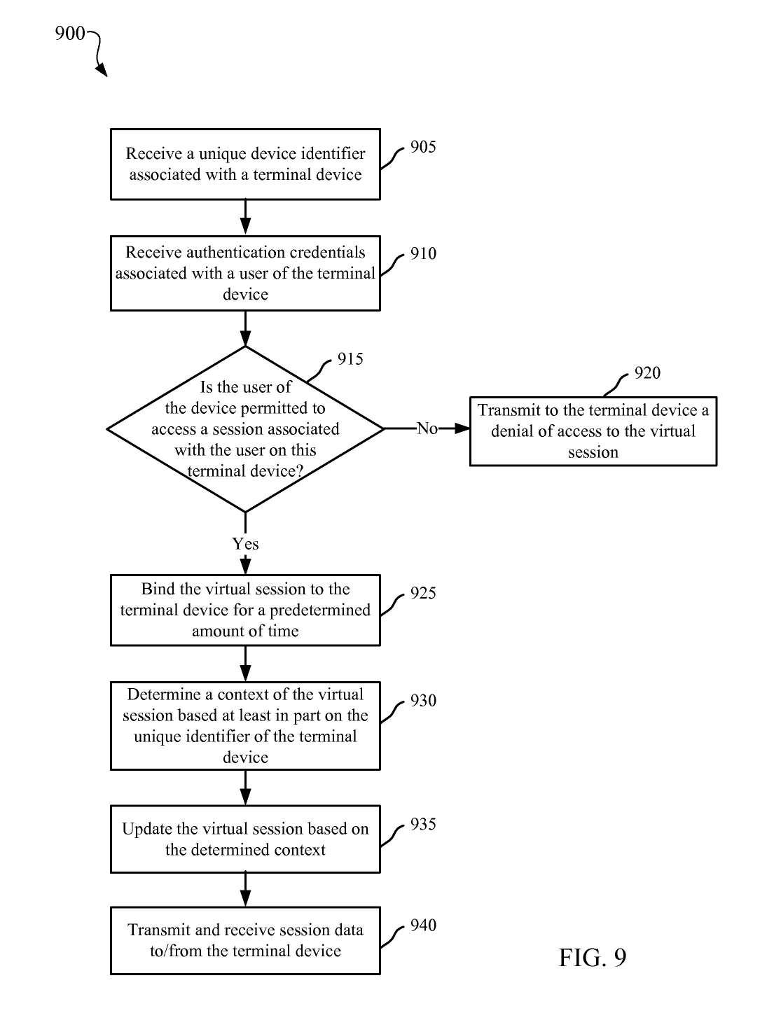

FIG. 9 is a flowchart diagram of an example method 900 of managing sessions according to the principles of the present disclosure. The method 900 may be performed, for example, by one or more of the central server computer systems 110, rules engines 115, or host devices 105 of the previous Figures. The method 900 of FIG. 9 may be an example of the method 800 of FIG. 8.

At block 905, a unique device identifier associated with a terminal device may be received. At block 910, authentication credentials associated with a user of the terminal device may be received. The unique device identifier and the user authentication credentials may be received together. At block 915, a determination is made regarding whether the user of the terminal device is permitted to access a session associated with the user on this particular terminal device. The determination may be made based on a set of stored access rules.

If access is not permitted (block 915, No), a denial of access to the virtual session may be transmitted to the terminal device 920. If access is permitted (block 915, Yes), the virtual session may be bound to the terminal device for a predetermined amount of time at block 925. A context of the virtual session may be determined based at least in part on the unique identifier of the terminal device. At block 935, the virtual session may be updated based on the determined context arising from the association of the virtual session of the user with the unique identifier of the terminal device. At block 940, data for the virtual session may be transmitted and received to and from the terminal device.

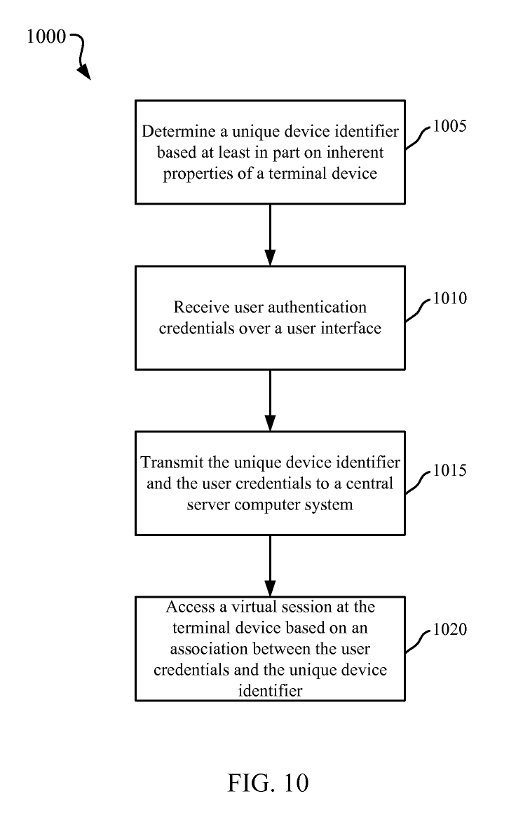

FIG. 10 is a flowchart diagram of an example method 1000 of managing virtual sessions according to the principles of the present disclosure. The method 1000 may be performed, for example, by one or more of the terminal devices 120 of the previous Figures.

At block 1005, a unique device identifier may be determined based at least in part on inherent properties of the terminal device. At block 1010, user authentication credentials may be received from a user over a user interface of the terminal device. At block 1015, the unique device identifier and the user credentials may be transmitted to a central server computer system. At block 1020, a virtual session may be accessed at the terminal device based on an association between the user credential and the unique device identifier. In certain examples, the virtual session may have been updated at the central server computer system based on an association of the virtual session with the terminal device.

The components and modules set forth in the foregoing Figures may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs) and other Semi-Custom ICs), which may be programmed in any manner known in the art. The functions of each unit may also be implemented, in whole or in part, with instructions embodied in a memory, formatted to be executed by one or more general or application-specific processors.

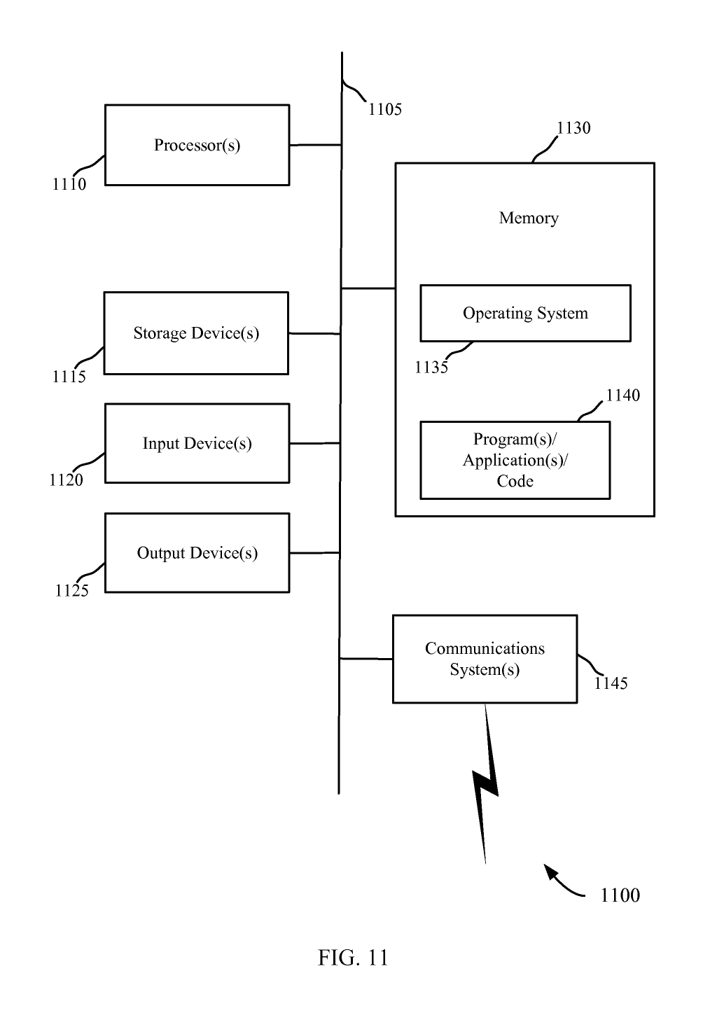

A device structure 1100 that may be used to implement one or more of the host device 105, the central server computer system 110, the rules engine 115, the terminal device 120, or other computing devices or modules described herein, is illustrated with the schematic diagram of FIG. 11. This drawing broadly illustrates how individual system elements of each of the aforementioned devices may be implemented, whether in a separated or more integrated manner.

The exemplary structure is shown comprised of hardware elements that are electrically coupled via bus 1105, including processor(s) 1110 (which may further comprise a DSP or special-purpose processor), storage device(s) 1115, input device(s) 1120, and output device(s) 1125. The storage device(s) 1115 may be a machine-readable storage media reader connected to any machine-readable storage medium, the combination comprehensively representing remote, local, fixed, or removable storage devices or storage media for temporarily or more permanently containing computer-readable information. The communications systems interface 1145 may interface to a wired, wireless, or other type of interfacing connection that permits data to be exchanged with other devices. The communications system(s) 1145 may permit data to be exchanged with a network.

The structure 1100 may also include additional software elements, shown as being currently located within working memory 1130, including an operating system 1135 and other code 1140, such as programs or applications designed to implement methods of the invention. It will be apparent to those skilled in the art that substantial variations may be used in accordance with specific requirements. For example, customized hardware might also be used, or particular elements might be implemented in hardware, software (including portable software, such as applets), or both.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices or other computer-readable mediums for storing information. The term “computer-readable medium” includes, but is not limited to, portable or fixed storage devices, optical storage devices, wireless channels, a SIM card, other smart cards, and various other mediums capable of storing, containing or carrying instructions or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method of managing virtual sessions, comprising:
authenticating a user of a terminal device based on at least one user authentication credential and a unique device identifier received from the terminal device;
associating a virtual session of the user with the terminal device based on the received unique device identifier and the at least one user authentication credential; and
updating the virtual session of the user according to at least one rule based on the association of the virtual session of the user with the terminal device.

2. The method of claim 1, further comprising:
determining, based on the unique device identifier, whether the user has permission to access the virtual session of the user through the terminal device;
wherein the association of the virtual session of the user with the terminal device is in response to the determination.

3. The method of claim 1, wherein the updating the virtual session of the user comprises:
preventing a second user from logging on to the terminal device while the terminal device is associated with the virtual session of the user.

4. The method of claim 1, further comprising:
determining a location of the terminal device based at least in part on the unique device identifier;
wherein the updating the virtual session is based on the location of the terminal device.

5. The method of claim 1, wherein the updating the virtual session of the user comprises:
adapting a user interface of the virtual session for display on the terminal device in response to the association of the virtual session with the terminal device.

6. The method of claim 1, wherein the updating the virtual session comprises:
changing at least one access permission associated with the virtual session based on the association of the virtual session of the user with the terminal device.

7. The method of claim 1, wherein the updating the virtual session comprises:
changing an execution status of at least one application of the virtual session based on the association of the virtual session of the user with the terminal device.

8. The method of claim 1, wherein the updating the virtual session comprises:
changing a display status of one or more elements of a user interface of the virtual session based on the association of the virtual session of the user with the terminal device.

9. The method of claim 1, wherein the updating the virtual session at the first terminal device comprises one or more of:
opening or closing a file in the virtual session based on the association of the virtual session of the user with the terminal device.

10. The method of claim 1, wherein the unique device identifier is based on at least a processor identifier and a media access control (MAC) address of the terminal device.

11. The method of claim 1, further comprising:
maintaining the association of the virtual session of the user with the terminal device for at least a predetermined period of time.

12. A central server computer system for managing at least one virtual session, the central server computer system comprising:
an authentication module configured to authenticate a user of a terminal device based on at least one user authentication credential and a unique device identifier received from the terminal device;
a session association module configured to associate a virtual session of the user with the terminal device based on the received unique device identifier and the at least one user authentication credential; and
a session updating module configured to update the virtual session of the user according to at least one rule based on the association of the virtual session of the user with the terminal device.

13. The central server computer system of claim 12, wherein the session association module is further configured to:
wherein the association of the virtual session of the user with the terminal device is in response to a determination that the user has permission to access the virtual session of the user through the terminal device.

14. The central server computer system of claim 12, wherein the session association module is further configured to:
prevent a second user from logging on to the terminal device while the terminal device is associated with the virtual session of the user.

15. The central server computer system of claim 12, wherein the session updating module is further configured to:
determine a location of the terminal device based at least in part on the unique device identifier; and
update the virtual session based on the location of the terminal device.

16. The central server computer system of claim 12, wherein the session updating module is further configured to:
adapt a user interface of the virtual session for display on the terminal device in response to the association of the virtual session with the terminal device.

17. The central server computer system of claim 12, wherein the session association module is further configured to:
maintain the association of the virtual session of the user with the terminal device for at least a predetermined period of time.

18. The central server computer system of claim 12, wherein the session updating module is further configured to:
change at least one access permission associated with the virtual session based on the association of the virtual session of the user with the terminal device.

19. The central server computer system of claim 12, wherein the session updating module is further configured to:
change an execution status of at least one application of the virtual session based on the association of the virtual session of the user with the terminal device.

20. The central server computer system of claim 12, wherein the session updating module is further configured to:
change a display status of one or more elements of a user interface of the virtual session based on the association of the virtual session of the user with the terminal device.

21. The central server computer system of claim 12, wherein the session updating module is further configured to:
open or close a file in the virtual session based on the association of the virtual session of the user with the terminal device.

22. The central server computer system of claim 12, wherein the unique device identifier is based on at least a processor identifier and a media access control (MAC) address of the terminal device.

23. A computer program product, comprising:
a tangible computer readable device comprising computer-readable instructions stored thereon, the computer-readable instructions configured to cause at least one processor, upon execution of the computer-readable instructions, to:
receive, at a central server computer system from a terminal device, at least one user authentication credential associated with a user of the terminal device;
receive, at the central server computer system, a unique device identifier associated with the terminal device in connection with the receipt of the at least one user authentication credential;
associate a virtual session of the user with the terminal device based on the received unique device identifier and the at least one user authentication credential; and
update the virtual session of the user according to at least one rule based on the association of the virtual session of the user with the terminal device.
